(19) United States
(12) Patent Application Publication
(10) Pub. No.: US 2010/0308106 A1
(43) Pub. Date: Dec. 9, 2010

(54) Barcode-Based Marketing System

(75) Inventor: Shean-Tung Lin, Taipei City (TW)

Correspondence Address: Yen Jung Sung, 21-80 38 St, #C8, Astoria, NY, 11105, US

(73) Assignee: Shean-Tung Lin, Taipei (TW)

(21) Appl. No.: 12/481,567

(22) Filed: Jun. 9, 2009

(51) Int. Cl. G06K 5/00; G06K 19/06; G06K 7/10

(52) U.S. Cl. 235/380; 235/494; 235/462.01

(57) ABSTRACT

A barcode-based marketing system includes a station, mobile devices and identification devices. The station is used for producing barcodes. The mobile devices are used for receiving the barcodes and transferring the barcodes to one another. The identification devices are used for communication with the station to read the barcodes and determine whether the barcodes are effective.

### FIELD OF THE INVENTION

The present invention relates to a barcode-based marketing system and, more particularly, to a system including a station for producing messages related to barcodes, mobile devices for receiving the messages from the station and communicating the messages with one another and identification devices for identifying the messages.

### DESCRIPTION OF THE RELATED ART

Shops, supermarkets, malls or department stores often hold promotion and offer special prices to stimulate consumption. Conventionally, the promotion and special prices are given via coupons provided alone or together with fliers or newspaper. With the coupons, consumers buy goods at discounted prices. The coupons get dirty or damaged during their delivery to the consumers. For not being able to identify the dirty or damaged coupons, clerks might refuse to offer discounts to consumers, thus causing troubles.

To overcome the above-mentioned problem, there is a barcode-based marketing system including a station for producing messages related to barcodes, a mobile device for receiving the messages and an identification device for identifying the messages. A shop, supermarket, mall or department store assigns a telecommunication service provider to send the messages to a consumer. With remarks included in the messages, the consumer knows the purposes of the messages and decides whether to pay for the barcodes. After payment, the consumer receives the barcodes and shows the barcodes to a clerk of the shop, supermarket, mall or department store. After identifying the barcodes with the identification device, the clerk delivers discounted or free-of-charge services or goods to the consumer.

With the barcode-based marketing system, there is no need for the coupons. The consumer has to pay the telecommunication service provider for sending the messages. The messages are effective for just once and cannot be communicated between consumers, thus rendering the costs high. It is therefore difficult to promote the barcode-based marketing system.

The present invention is therefore intended to obviate or at least alleviate the problems encountered in prior art.

### SUMMARY OF THE INVENTION

It is the primary objective of the present invention to provide a barcode-based marketing system enable consumers to share barcodes.

To achieve the foregoing objective, the barcode-based marketing system includes a station, mobile devices and identification devices. The station is used for producing barcodes. The mobile devices are used for receiving the barcodes and transferring the barcodes to one another. The identification devices are used for communication with the station to read the barcodes and determine whether the barcodes are effective.

Other objectives, advantages and features of the present invention will become apparent from the following description referring to the attached drawings.

### BRIEF DESCRIPTIONS OF THE DRAWINGS

The present invention will be described via detailed illustration of the preferred embodiment referring to the drawings.

FIG. 1 is a perspective view of a barcode-based marketing system according to the preferred embodiment of the present invention.

FIG. 2 is a block diagram of the barcode-based marketing system shown in FIG. 1.

### DESCRIPTION OF THE PREFERRED EMBODIMENT

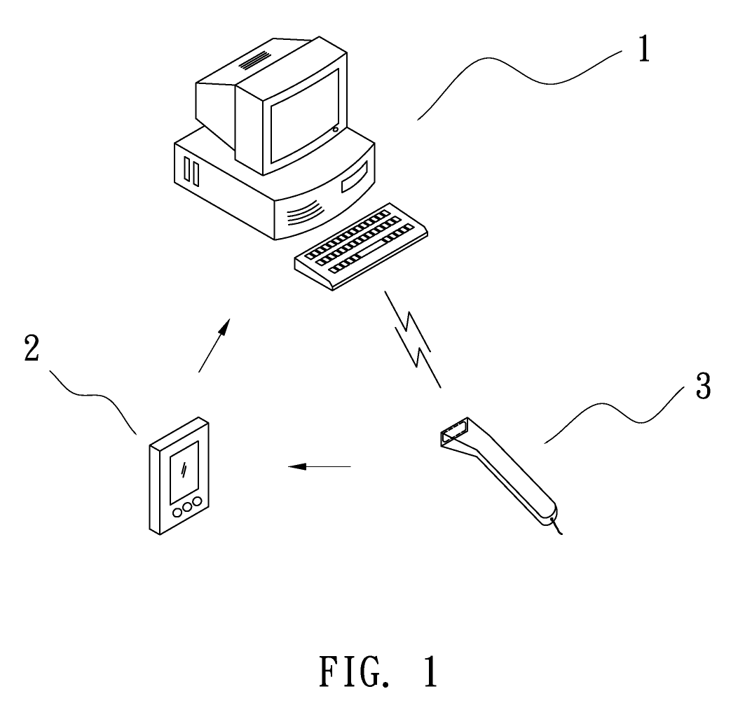

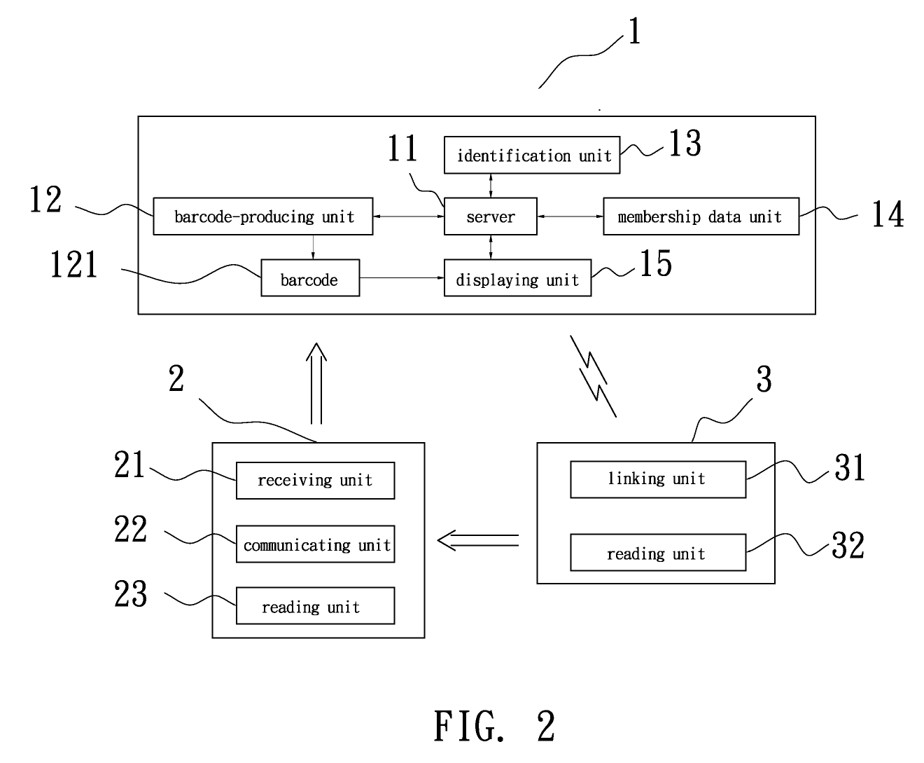

Referring to FIGS. 1 and 2, a barcode-based marketing system includes a station 1 for producing messages related to barcodes, mobile devices 2 for receiving the messages from the station 1 and communicating the messages with one another and identification devices 3 for identifying the messages according to the preferred embodiment of the present invention. The messages are shared by the mobile devices 2 without involving a telecommunication service provider.

The station 1 includes a server 11, a barcode-producing unit 12, an identification unit 13, a membership database unit 14 and a displaying unit 15. The barcode-producing unit 12 is connected to the server 11. The barcode-producing unit 12 is used to produce barcodes 121 that can be related to numbers or words. The barcodes 121 can be shown on the displaying unit 15.

The mobile devices 2 can be cellular phones, personal digital assistants or laptop computers. Each of the mobile devices 2 includes a receiving unit 21, a communication unit 22 and a reading unit 23. The receiving unit 21 receives the barcodes 121. The communication unit 22 communicates the barcodes 121 with the communication unit 22 of another mobile device 2. The reading unit 23 reads the barcodes 121.

The identification devices 3 can be scanners. Each of the identification devices 3 includes a linking unit 31 and a reading unit 32. The linking unit 31 is linked to the station 1 with cables or in a wireless manner. The identification devices 3 can be linked to the station 1 to read the barcodes 121 and determine whether the barcodes 121 are effective.

In operation, the barcode-producing unit 12 of the station 1 produces a barcode 121 based on promotion or special offers. A consumer or member attempts access to the station 1 through the server 11. The identification unit 13 and the membership data unit 14 together identify the memberships of the consumers. Once identified, the consumer gets access to the station 1. With input of related data, the displaying unit 15 shows the barcode 121 or data related to the membership.

With the receiving unit 1 of a related one of the mobile devices 2, the consumer receives the barcode 121 shown on the displaying unit 15. The mobile device 2 shows the barcode 121 for confirmation. After confirmation, the consumer can use the barcode 121 in a shop, supermarket, mall or department store. The consumer can use the communication unit 22 of the mobile device 2 to forward the barcode 121 to another consumer using another mobile device 2.

The consumer shows the barcode 121 on the mobile device 2 to a clerk in the shop, supermarket, mall or department. The clerk uses the linking unit 31 of the identification device 3 to link to the station 1 to get access to data related to the membership of the consumer. Then, the clerk uses the reading unit 32 to read the barcode 121. Based on the barcode 121, the clerk provides discounted or free-of-charge service or goods to the consumer. Then, related data are sent to the membership data unit 14 of the station 1 so that the number of times of transfer of the barcode 121 between the consumers can be learned and controlled.

Advantageously, the barcode 121 can be shared by the consumers using the mobile devices 2 so that the cost of delivering the barcode 121 to consumers is low. Moreover, the number of times of transfer of the barcode 121 between the consumers can be learned and controlled.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

What is claimed is:

1. A barcode-based marketing system comprising:
a station for producing barcodes;
a plurality of mobile devices for receiving the barcodes and transferring the barcodes to one another; and
identification devices for communication with the station to read the barcodes and determine whether the barcodes are effective.

2. The barcode-based marketing system according to claim 1, wherein the station comprises:
a server;
a barcode-producing unit connected to the server and used to produce the barcodes;
a membership data unit connected to the server and used to store membership data;
an identification unit connected to the server and used to identify a member based on the membership data; and
a displaying unit for displaying the barcodes.

3. The barcode-based marketing system according to claim 1, wherein the barcodes are related to numbers or words.

4. The barcode-based marketing system according to claim 1, wherein each of the mobile devices comprises:
a receiving unit for receiving the barcodes;
a communication unit for communicating the barcodes with the communication unit of another mobile device; and
a reading unit for reading the barcodes.

5. The barcode-based marketing system according to claim 1, wherein each of the mobile devices is selected from a group consisting of a cellular phone, a personal digital assistant and a laptop computer.

6. The barcode-based marketing system according to claim 1, wherein each of the identification devices comprises a linking unit for linking to the station and a reading unit for reading the barcode; and wherein the linking unit is connected with the server through wire or wirelessly.

7. The barcode-based marketing system according to claim 1, wherein each of the identification devices is a scanner.

8. The barcode-based marketing system according to claim 1, wherein the number of times of transfer of the barcodes between the mobile devices is controlled.

9. A station comprising:
a server for interfacing with consumers;
a barcode-producing unit connected to the server and used to produce barcodes;
an identification unit connected to the server and used to identify a member based on membership data;
a membership data unit connected to the server and used to control the number of times of transfer of the barcodes between members; and
a displaying unit for displaying the barcodes and the membership data.

10. The station according to claim 9, wherein the barcode is transferred through wires.

11. The station according to claim 9, wherein the barcode is transferred wirelessly.
